(19) United States
(12) Patent Application Publication
(10) Pub. No.: US 2004/0153420 A1
(43) Pub. Date: Aug. 5, 2004

(54) Method of recording in a chip card and chip card for implementing this method

(76) Inventors: Sylvie Andraud, Paris (FR); Evelyne Zwaenepoel, Saint-Mande (FR); Claude Meggle, Paris (FR)

Correspondence Address: MCCRACKEN & FRANK LLP, 200 W. ADAMS STREET, SUITE 2150, CHICAGO, IL, 60606, US

(21) Appl. No.: 10/619,106

(22) Filed: Jul. 14, 2003

(30) Foreign Application Priority Data
Jul. 19, 2002 (FR) FR 02 09205

(51) Int. Cl. G06F 17/60

(52) U.S. Cl. 705/75

(57) ABSTRACT

To generate a tangible element of proof which guarantees that a specified transaction has been carried out using a specified microcircuit card, the method comprises steps in which a microprocessor, contained in the microcircuit, records, in an internal memory of the microcircuit, a cryptogram on the data of the transaction, as soon as it detects a confirming event for validating the transaction, the microprocessor then transmits a transaction validation signal out of the card, after having recorded the cryptogram in the internal memory.

The field of the invention is that of transactions validated by a communication between a terminal and a protected microcircuit.

Microcircuit cards or chip cards in which the microcircuit comprises a microprocessor and an internal memory are for example known.

The internal memory of each card contains means for recognizing a secret code specific to the card so as to validate a transaction only when the card holder communicates a code which corresponds to the secret code. The microcircuit being protected against intrusions, a validation of transaction by the card is recognized as constituting proof according to which the card's legitimate holder has accepted the transaction.

The known state of the art discloses numerous means for securing the microcircuit, the terminal and the communications between the microcircuit and the terminal, such as cryptographic methods, and destruction upon attempted break-in.

However, the legitimate holder of the card may be tempted to refute the proof by pretending for example that the malfunctioning of the terminal or of the means of communication with the terminal, or else the purloining of the card and of its secret code without his knowledge, are to blame for a false proof.

Moreover, when the transaction relates to the debiting of a bank account associated with the card, the validation is generally accompanied by an account identification forwarded by the microcircuit of the card during the transaction.

The legitimate holder of the bank account may wish to repudiate the transaction by pretending for example that the identification of his account was forwarded by a card other than his own, an illegitimate clone or another card which had legitimately been associated with his account but which he has since put a stop on.

A first object of the invention is a method of generating a tangible element of proof which guarantees that a transaction has been carried out using a microcircuit card when this card has actually served to carry out this transaction.

The microcircuit of the card comprising a microprocessor and an internal memory, the method according to the invention is noteworthy in that it comprises steps in which:

the microprocessor records, in the internal memory, a cryptogram on the data of the transaction, as soon as it detects a confirming event for validating the transaction,

the microprocessor transmits a transaction validation signal out of the card, after having recorded the cryptogram in the internal memory.

The recording, in the internal memory, of the cryptogram on the data of the transaction constitutes a material and hence tangible element of proof that the transaction to the data of which the cryptogram pertains, has been carried out with the aid of the card. If the legitimate holder of the card attempts to repudiate the transaction, it is then possible to order a readout of the internal memory so as to reveal the cryptogram.

The transmission of the validation signal after having recorded the cryptogram prevents a transaction being validated without the cryptogram being recorded. If the holder of the card withdraws the latter from the reader that supplies it with power so as to halt the operation thereof, the withdrawal of the card immediately after the transmission of the validation signal cannot prevent the cryptogram being recorded.

The fact that the recording in the internal memory is performed by the microprocessor of the card as soon as the former detects a confirming event prevents an outside element from imposing a falsified recording in the card.

A second object of the invention is a microcircuit card comprising a microprocessor and an internal memory. Particularly suitable for implementing the method according to the invention, the card is noteworthy in that the internal memory comprises a microprogram executable by the microprocessor of the microcircuit. This microprogram is devised so as:

to record, in the internal memory, a cryptogram on the data of each transaction, for the detection of a confirming event for validating the transaction,

to transmit a transaction validation signal out of the card, after having recorded the cryptogram in the internal memory.

Other details and advantages of the invention will be better understood with the aid of the implementational description which follows with reference to the appended drawings in which:

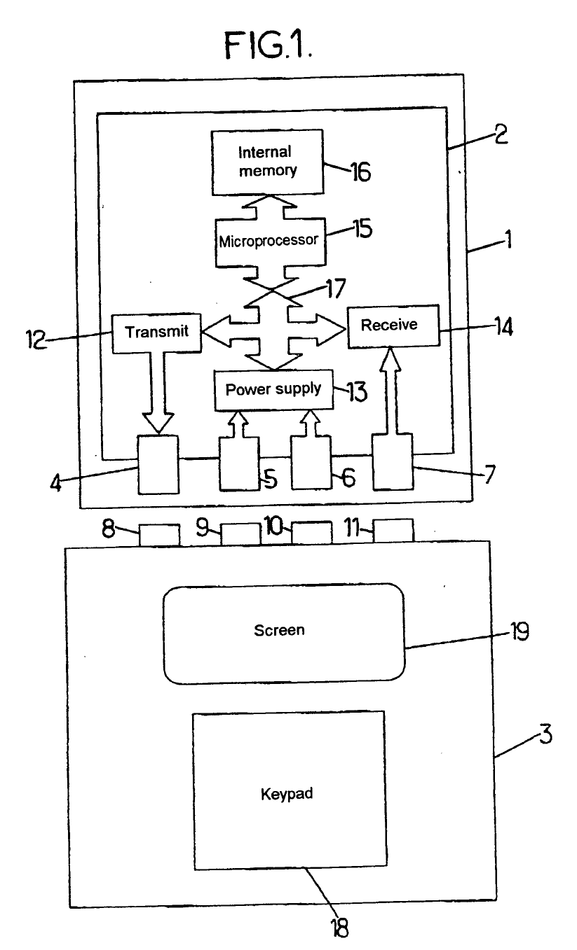

FIG. 1 depicts a microcircuit card diagram in accordance with the invention;

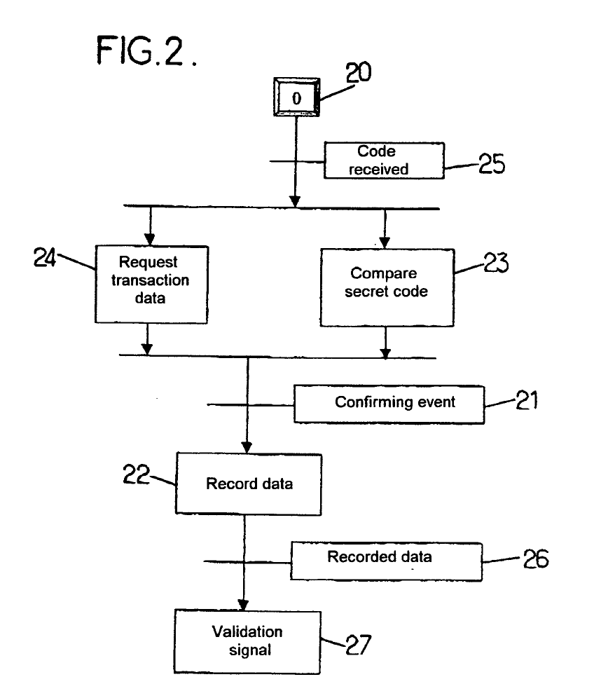

FIG. 2 depicts method steps in accordance with the invention.

With reference to FIG. 1, a card 1 comprises a microcircuit 2 protected against intrusions.

Various flat pads 4, 5, 6, 7 protrude from the microcircuit 2 on the card 1. The flat pads 4, 5, 6, 7 are provided so as to be brought into electrical contact with flat pads 8, 9, 10, 11 of a card reader 3 when the card 1 is inserted into the reader 3.

The number of pads is not limiting. It is known for example that numerous cards possess eight flat pads.

The microcircuit 2 comprises a microprocessor 15 and an internal memory 16. An internal bus 17 allows the microprocessor 15 to process digital data received by reception means 14 connected to the flat pad 7, digital data to be transmitted by transmission means 12 connected to the flat pad 4, with the aid of digital data contained in the memory 16.

Supply means 13 connected to the flat pads 5 and 6 are devised to supply electrical power to the microprocessor 15, the internal memory 16, the reception means 14 and the transmission means 12. The internal memory 16 is such that it retains its data in the absence of power supply.

The reader 3 comprises in a known manner a keypad 18 and a screen 19.

To perform a transaction, the card 1 is inserted into the reader 3 in such a way as to place each of the pads 4, 5, 6, 7 in electrical contact with each of the pads 8, 9, 10, 11 respectively.

The pads 9 and 10 provide the electrical power supply to the card 1. The pad 8 allows the reader 3 to receive the digital data transmitted by the card 1. The pad 11 allows the reader 3 to transmit digital data to the card 1.

The user of the card, seeing a transaction amount on the screen 19, types his confidential code on the keypad 18. The reader 3 then sends the confidential code to the microcircuit 2 via the pad 11. The reader 3 considers the transaction validated when it receives a validation signal on the pad 8 in such a way as to perform the transaction internally if the reader 3 constitutes a terminal or to perform the transaction externally on a terminal in communication with the reader 3.

The internal memory 16 contains a microprogram executable by the microprocessor, especially devised to implement the method now explained with reference to FIG. 2.

An initialization step 20 is activated by powering up the microcircuit 2 when the pads 5 and 6 are in contact with the pads 9 and 10.

When the microprocessor 15 detects a confirming event for validating the transaction, a transition 21 activates a step 22.

In step 22, the microprocessor 15 calculates a cryptogram on the data of the transaction and records it in the internal memory 16. The cryptogram constitutes a signature of the data of the transaction comprising for example a date (year, month, day, hour, minutes) and a monetary amount.

If a subsequent dispute occurs concerning the transaction, a readout of the cryptogram in the microcircuit makes it possible to prove that the cryptogram actually corresponds to this transaction.

The entire data could be recorded. However, the cryptogram offers the advantage of a more compact recording which uses less room in internal memory while offering the adequate guarantees of security obtained via cryptographic functions, for example known hash functions or public key encryption functions.

The cryptogram is improved when it also pertains to the transaction data which comprise a transaction destination identifier. This makes it possible to ensure that the transaction has not been hijacked.

The reliability of the recording is strengthened through the fact that it is the processor 15 itself that generates the confirming event for the transition 21 and not some outside equipment such as the reader 3 or any other terminal.

Advantageously, the confirming event results from a comparison performed by the microprocessor 15 in a step 23. The step 23 is activated from step 20, via a transition 25 which corresponds to reception of a confidential code received by the microcircuit 2.

In step 23, the microprocessor 15 executes the microprogram devised to perform the comparison in such a way as to generate the confirming event when the code received is equal to a secret code held in the internal memory 16.

The transition 25 also activates a step 24 in which the microprocessor 15 executes the microprogram devised for this purpose so as to receive the data of the transaction. If the transaction data are not sent systematically by the reader 3 to the microcircuit 2, the microprogram contains instructions for requesting these data.

When the microprocessor 15 recognizes an acknowledgement according to which the data or preferably the cryptogram have been recorded in the memory 16, a transition 26 activates a step 27.

In step 27, the microprocessor 15 transmits a validation signal that the transmission means 12 send to the reader 3 via the pads 4 and 8.

1. Method of generating a tangible element of proof which guarantees that a specified transaction has been carried out using a specified microcircuit card, the microcircuit of the said card comprising a microprocessor and an internal memory, comprising steps wherein:
the microprocessor records, in the internal memory, a cryptogram on the data of the transaction, as soon as it detects a confirming event for validating the transaction,
the microprocessor transmits a transaction validation signal out of the card, after having recorded the cryptogram in the internal memory.

2. Method according to claim 1, wherein the said confirming event results from a comparison performed by the microprocessor which verifies that a code received is equal to a secret code held in the internal memory.

3. Method according to claim 1, wherein the data of the transaction comprise a date and a monetary amount.

4. Method according to claim 3, wherein the data of the transaction comprise a transaction destination identifier.

5. Microcircuit card comprising a microprocessor and an internal memory for performing transactions with a terminal, wherein the internal memory contains a microprogram executable by the microprocessor of the microcircuit and devised so as:
to record, in the internal memory, a cryptogram on data of each transaction, when detecting a confirming event for validating the transaction,
to transmit a transaction validation signal out of the card, after having recorded the cryptogram in the internal memory.

6. Microcircuit card according to claim 5, wherein the microprogram is devised to perform a comparison from which the said confirming event results when a code received is equal to a secret code held in the internal memory.

7. Microcircuit card according to claim 5, wherein the microprogram is devised to receive the data of the transaction which comprise a date and a monetary amount.

8. Microcircuit card according to claim 7, wherein the microprogram is devised to receive the data of the transaction which comprise a transaction destination identifier.
